(19) United States
(12) Patent Application Publication
(10) Pub. No.: US 2013/0163928 A1
(43) Pub. Date: Jun. 27, 2013

(54) Polymer Waveguide for Coupling with Light Transmissible Devices and Method of Fabricating the Same

(71) Applicants: Xizu Wang, Singapore (SG); Hoi Lam Tam, Singapore (SG); Zhikuan Chen, Singapore (SG); Furong Zhu, Singapore (SG)

(72) Inventors: Xizu Wang, Singapore (SG); Hoi Lam Tam, Singapore (SG); Zhikuan Chen, Singapore (SG); Furong Zhu, Singapore (SG)

(73) Assignee: AGENCY FOR SCIENCE, TECHNOLOGY AND RESEARCH, Singapore (SG)

(21) Appl. No.: 13/812,929

(22) PCT Filed: Aug. 4, 2011
(86) PCT No.: PCT/SG2011/000273

§ 371 Date: Mar. 12, 2013

Related U.S. Application Data
(60) Provisional application No. 61/370,489, filed on Aug. 4, 2010.

(51) Int. Cl. G02B 6/02

(52) U.S. Cl. CPC G02B 6/02057; G02B 6/02066; G02B 6/02076; Y10S 977/887; B82B 3/0095
USPC 385/37; 427/163.2; 216/24; 430/321; 977/887

(57) ABSTRACT

A polymer waveguide for coupling with one or more light transmissible devices, a method of fabricating a polymer waveguide for coupling with one or more light transmissible devices, and a method of coupling a polymer waveguide with one or more light transmissible devices. The polymeric waveguide comprises a grating structure.

### FIELD OF INVENTION

The present invention relates broadly to a polymer waveguide for coupling with light transmissible devices, to a method of fabricating the same, and to a method of coupling a polymer waveguide with one or more light transmissible devices.

### BACKGROUND

The function of a waveguide is to transmit a light signal. The light is restricted to transmit in the core layer in a multilayer waveguide, e.g., a 3-layer configuration of overclad/core/underclad. The main challenge is achieving high light in-coupling and out-coupling efficiency at the waveguide interfaces, for example at the waveguide/ organic light emitting diodes (OLEDs) and waveguide/organic photo-detectors (OPDs) interfaces.

The simplest structure that combines a device such as a light source or a light detector with a polymeric waveguide is that the device is formed in contact with the waveguide, for example, at the bottom or on the top of the waveguide. The top and bottom approach can work with a single layer waveguide but typically not a multilayer waveguide that consists of the cladding layers with refractive indices less than the core. This is because the cladding layer reflects the emission from e.g. the light source instead of coupling the emission to the waveguide mode inside the core layer. The reflection occurs both at the initial interface to the cladding layer, as well as at the interface between the cladding layer and the core layer.

A number of approaches have been presented for an integrated light source (LED, laser and OLED) and photodetector (organic and inorganic) with a polymer waveguide. Marc Ramuz et al [“Light from an organic light emitting diode (OLED) into a single-mode waveguide: Toward monolithically integrated optical sensors”, J. Appl. Phys. 105, (2009) 084508], reported an integrated device with OLED and OPD fabricated on an inorganic waveguide. They proposed using an evanescent coupling approach to couple the emission from the OLED to the single layer waveguide. This approach relies on the intimate contact between the OLED and the waveguide as it is a near field coupling. Yutaka Ohmori et at [IEEE J. Sel. Top. Quant. 10 (2004) 70], reported an integrated device with OLED and OPD fabricated on a polymer waveguide. The structure includes a 45° cut mirror, which helps to direct light from the OLED into the waveguide. However, the reported designs have a number of deficiencies and limitations, including that the integration of OPD with inorganic waveguides is not suitable for flexible substrate applications. Also, most waveguides have a cladding layer, which prevents any signal loss from the core and also causes reduction in coupling light in and out efficiency at light source/cladding layer and cladding layer/detector interfaces due to internal reflection. Also, the angular cut mirror is not suitable for ultra-thin waveguides and entails the use of complex processing technology.

A need therefore exists to provide integration of light transmissible devices with a polymer waveguide, that seeks to address at least one of the above-mentioned problems.

### SUMMARY

In accordance with a first aspect of the present invention there is provided a polymer waveguide for coupling with one or more light transmissible devices, wherein the polymeric waveguide comprises a grating structure.

The polymer waveguide may comprise an underclad layer, a core layer and an overclad layer, and the grating structure is formed at an interface between the overclad layer and the core layer, or at an interface between the underclad and the core layer.

The polymer waveguide may be disposed on a substrate.

The grating structure may be formed in the core layer of the polymeric waveguide.

The grating structure may be periodic.

The periodic grating structure may be corrugated.

The periodic grating structure may have an oscillating refractive index along a plane substantially parallel to the light transmissible devices.

The substrate may comprise one of a group consisting of PET, glass, a stainless steel foil, a plastic sheet, a circuitry backplane, and a flexible substrate.

The grating structure may be fabricated by nano- or micro-fabrication method.

The grating structure may be fabricated by one of a group consisting of nanoimprint, e-beam etch and photo-lithography.

The period of the grating may be tuned by the nanoimprint process.

The grating structure may change a propagation direction of light emission from the light transmissible device.

The polymer waveguide may be configured for coupling of light from one or more light transmissive devices, and/or coupling of light to one or more light transmissive devices.

The one or more light transmissible devices may be selected from a group consisting of laser, a solid-state lighting, an organic light emitting diode, a polymer light emitting diode, a light emitting diode, an electroluminescent unit, an inorganic photodetector, an organic photodetector or a combination thereof.

The polymer waveguide may further comprising a transparent protective layer in an area of the grating structure.

The transparent protective layer may be selected from a group consisting of ZnO, SnO₂, In₂O₃, Al₂O₃, NiO, CaF₂, an organic material suitable for application in a grating, and inorganic material suitable for application in a grating, or a combination thereof.

The transparent protective layer may further comprises a transparent conducting layer.

The transparent conducting layer may comprise transparent conducting oxides such as indium-tin-oxide (ITO), zinc-indium-oxide, aluminum-doped zinc oxide, Ga—In—Sn—O, SnO2, Zn—In—Sn—O, Ga—In—O, TiNbO, ZSO, NiOx or a combination of transparent conducting oxides.

The transparent conducting layer may comprise ultra-thin metallic or modified metallic materials such as Au, Ag/CFx or any transparent conducting layer suitable for application in OLEDs and OPDs.

In accordance with a second aspect of the present invention there is provided a method of fabricating a polymer waveguide for coupling with one or more light transmissible devices, the method comprising the step of providing a grating structure in the polymer waveguide.

The polymer waveguide may comprise an underclad layer, a core layer and an overclad layer, and the grating structure is formed at an interface between the overclad layer and the core layer, or at an interface between the underclad and the core layer.

The step of providing the grating may comprise nanoimprint, e-beam etch or photolithography.

The method may further comprise the step of depositing a transparent protective layer in an area of the grating structure.

The transparent protective layer may be selected from a group consisting of ZnO, SnO₂, In₂O₃, Al₂O₃, NiO, CaF₂, an organic material suitable for application in a grating, and inorganic material suitable for application in a grating, or a combination thereof.

The transparent protective layer may further comprise a transparent conducting layer.

The transparent conducting layer may comprise transparent conducting oxides such as indium-tin-oxide (ITO), zinc-indium-oxide, aluminum-doped zinc oxide, Ga—In—Sn—O, SnO2, Zn—In—Sn—O, Ga—In—O, TiNbO, ZSO, NiOx or a combination of transparent conducting oxides.

The transparent conducting layer may comprise ultra-thin metallic or modified metallic materials such as Au, Ag/CFx or any transparent conducting layer suitable for application in OLEDs and OPDs.

In accordance with a third aspect of the present invention there is provided a method of coupling a polymer waveguide with one or more light transmissible devices using a grating structure formed in the polymer waveguide structure.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram of diffracted light via a grating structure.

FIG. 2 shows a schematic drawing of diffracted light via a grating structure, illustrating the in-plane component.

FIG. 3 shows a schematic diagram illustrating light coupling with polymer waveguide via a grating structure, in accordance with an embodiment of the present invention.

FIG. 4 shows a flow chart illustrating the fabrication of a built-in grating structure in polymer waveguides by the nanoimprint technique, according to an embodiment of the present invention.

FIG. 5 shows the photo pictures demonstrating the light in-coupling and out-coupling in a polymer waveguide using 530 nm and 630 nm lasers, according to embodiments of the present invention.

### DETAILED DESCRIPTION

Embodiments of the present invention provide structures and methods for integration of light transmissible devices with a polymer waveguide for efficient optical coupling, wherein the polymeric waveguide comprises a grating structure, to enhance the optical coupling efficiency at light source/polymer waveguide and polymer waveguide/detector interfaces.

One embodiment of the present invention provides a method of fabricating a polymer waveguide, the method comprising the step of providing a grating in a core of the polymer waveguide.

Integration of organic light transmissible devices including organic light emitting diodes (OLEDs) and organic photo-detectors (OPDs) with polymer waveguides (WG) is advantageous for applications in organic electronics including imaging sensors, biological sensors, chemical sensors, position sensors, optical detectors, optical communications, optical switches and other flexible electronic devices. The light coupling efficiency at WG/OLEDs and WG/OPDs interfaces plays an important role in determining the properties of the devices. Integration of OLEDs and OPDs with polymer waveguides possesses many advantages such as low cost, large area, flexibility and simple device fabrication process. The functions of integrated light transmissible devices can also be expanded to other devices, including, but not limited to the combination of laser, inorganic LED sources, inorganic photodetectors, OLED, OPDs and WGs. By integrating e.g. a light source and photo-detector with a polymer waveguide, the integrated system can be used in more sophisticated functional devices, such as variable optical attenuators, modulators, optical switches, biological and chemical sensors. For these applications, one of the parameters to be considered is the coupling light in or out efficiency.

A typical polymer waveguide has a multilayer structure consisting of a top cladding layer, a core layer and a bottom cladding layer The refractive index of the core is higher than that of the cladding layers. Since the refractive index of the cladding materials is lower than that of the core layer, light travelling inside the core layer will then be confined. In example embodiments of the present invention, the cladding and core layers that form a functional waveguide are spin-coated on a Si wafer. The real part of the complex refractive index of the cladding layer is about 1.53 to 1.57, and that measured for the core layer is 1.59. However, it will be appreciated that the present invention is not limited to spin-coating on a Si wafer and the particular complex refractive indices.

Example embodiments of the present invention enable the coupling of emission from e.g. light sources into the core layer of a polymer waveguide, in particular a multilayer polymer waveguide. Example embodiments of the present invention provide a grating structure at the interface between the cladding layer and the core layer for efficient light coupling in or out at the interface between transmissible devices and the polymeric waveguide which advantageously allows efficient optical coupling between the light sources and e.g. detectors with the polymeric waveguide. In an embodiment, the grating structure can be fabricated using a nano- or micro-fabrication method, for example, a nanoimprint process. However, it will be appreciated that the present invention is not limited to a nanoimprint process, and other processes, such as, but not limited to, a lithography process, can be used in different embodiments.

Example embodiments of the present invention further provide an intimate transparent protection layer in the waveguide, so that the periodic grating structure can preferably be created at the cladding layer to core layer interface of the waveguide without for example deterioration/erasure of the grating structure during the subsequent processing steps. The transparent protection layer can be selected from a group consisting of ZnO, SnO₂, In₂O₃, Al₂O₃, NiO, CaF₂, and any organic and inorganic material suitable for application in grating or a combination thereof. Further, the protection layer can incorporate transparent conductive oxides (TCOs). It will further be appreciated that TCO may comprise transparent conducting oxides such as indium-tin-oxide (ITO), zinc-indium-oxide, aluminum-doped zinc oxide, Ga—In—Sn—O, SnO2, Zn—In—Sn—O, Ga—In—O, TiNbO, ZSO, NiOx or a combination of different transparent conducting materials. Also, the transparent conductive layer may comprise untra-thin metallic or modified metallic materials such as Au, Ag/CFx or any organic and inorganic transparent electrode contact suitable for application in OLEDs and OPDs.

The grating structure acts as a platform for coupling light in or out of the waveguide. Separate grating structures can be provided for coupling light in or out, respectively. Advantageously, the grating structure assists in enhancing the coupling efficiency between the light source and detector with the waveguide.

The grating structures of example embodiments act to couple light from the directional emission of the light source. Adjusting the periodicity of the grating structure enables the coupling of light emission from different emission angles from the light source.

For a diffraction grating, the required periodicity of the grating structure at a selected wavelength and diffracted angle can be calculated using Equation (1):

mλ=nd sin(θ) Equation (1)

where θ is the diffracted angle, λ is the diffracted wavelength, d is the periodicity, n is the refractive index of the medium after grating (in this case is air, n=1) and m is the “order number” with a positive integer (m=1, 2, 3, . . . ) representing the repetition of the spectrum.

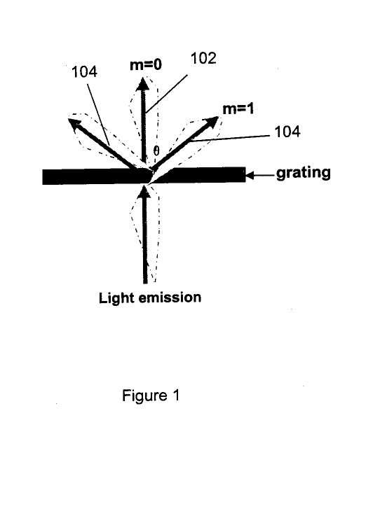

A schematic drawing for illustration purposes is shown in FIG. 1. The intensity ratio of 0 and 1st order diffracted light 102, 104 respectively varies with the type of corrugated structure and the refractive index of the material used. In example embodiments, a 1D grating with a d of about 500 nm is fabricated. For λ=530 nm normal emission light, the light will be diffracted to 1st order diffraction grating angle, which is θ=46.5° away from the normal.

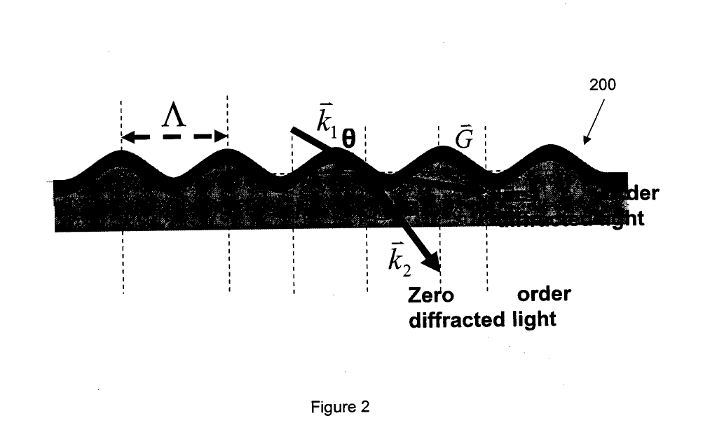

FIG. 2 shows a schematic drawing of diffracted light via a grating structure 200 at the OLED/WG interface, illustrating an in-plane component.

For the diffraction grating 200 of FIG. 2, the required periodicity of the grating structure at a selected wavelength and diffracted angle can be calculated using Equations (2a) and (2b):

$$\begin{matrix}{{k}^{->}}_{1 \vert \vert} + {G}^{->} = {{k}^{->}}_{3 \vert \vert} & Equation ( 2 a ) \\ \frac{2 π}{λ} \cdot {n}_{overclad} \cdot sin θ + \frac{2 π}{Λ} = \frac{2 π}{λ} \cdot {n}_{core} \cdot sin α & Equation ( 2 b )\end{matrix}$$

where θ is the incident angle, α is the diffracted angle, λ is the diffracted wavelength, Λ is the periodicity, n is the refractive index of the medium on both sides (overclad, core, respectively) of the grating (in this case n_{overload} is air, n=1) and m is the “order number”. In example embodiments, a 1D grating with d of about 500 nm is fabricated.

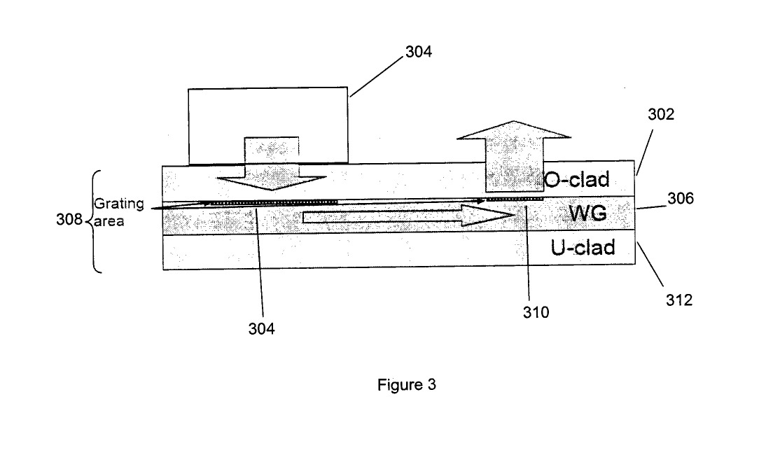

The grating coupling structure of example embodiments can be used both for light coupling in or out of the polymer waveguide, as shown in FIG. 3. The light can pass through the overclad layer 302 from the light source 304, towards a first grating structure 304 for coupling into the core 306 of the polymer waveguide 308. That is, in example embodiments of the present invention, while there may be reflection losses incurred at the initial interface to the overclad layer 302, advantageously reflection can be reduced at the interface between the overclad 302 and the core 306, and coupling into the core 306 can be achieved.

As the light reaches a second grating structure 310, the light can advantageously couple out from the core 306 instead of experiencing total internal reflection at the core 306 to overclad layer 302 interface, and out of the overclad layer 302. The grating structures 304, 310 can be periodic. In example embodiments, the periodic gratings are corrugated. The periodic gratings can have an oscillating refractive index along a plane substantially parallel to the light source. It will be appreciated that the configuration in FIG. 3 can be readily implemented for coupling in and out via the underclad layer 312 by e.g. placing the grating structures at the interface between the underclad layer 312 and the core 306.

Example embodiments of the present invention provide a process for fabricating a grating structure in the middle of a polymer waveguide preferably without causing substantially any deterioration in the waveguide property or without causing substantially any damage to the functional materials during the process. The grating structure can be made with nanoimprinting technology in one embodiment. The imprint resist is typically a monomer or polymer formulation that is cured by heat or UV light during the imprinting process. It is similar to the fabrication process of the core layer of the polymer waveguide. In example embodiments, the nanoimprint is used for fabrication of the grating structure(s) on designated area(s) preferably without damaging or affecting the whole core layer.

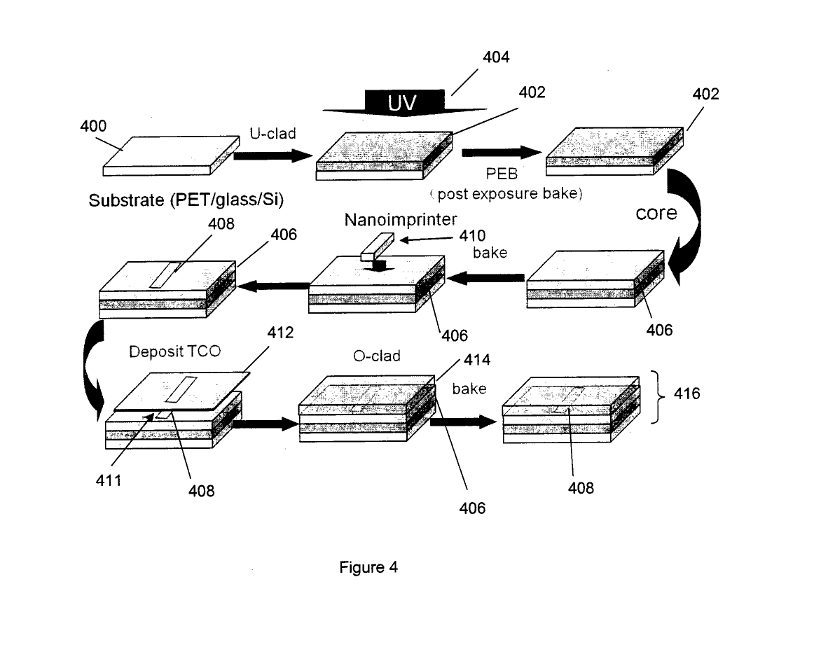

In one example embodiment of the present invention, a 3-layer (overclad/core/underclad) polymer waveguide on a silicon substrate is used. FIG. 4 shows the fabrication process of this example embodiment of the present invention.

Starting from a silicon substrate 400, noting that the present invention is not limited to a silicon substrate, and other substrates such as, but not limited to, PET or glass or stainless steel foil or plastic sheets or circuitry backplane, and underclad polymer layer 402 is spin-coated onto the substrate 400, and UV irradiation 404, for example, using a UV lamp with a peak wavelength of 365 nm, and a post expose bake (PEB) are carried out to cure the layer 402. A polymer core layer 406 is then spin-coated on the underclad layer 402, and cured by baking. The grating structure 408 is then fabricated on the core layer 406 via a nanoimprinting technique 410. Details of the nanoimprinting technique will be understood by a person skilled in the art, and will not be described in detail herein. Reference is made to [“Polymeric Wavelength Filter Based on a Bragg Grating Using Nanoimprint Technique, Seh-Won Ahn, Ki-Dong Lee, Do-Hwan Kim and Sang-Shin Lee, IEEE Photonics Technology Letters, Vol. 17, No. 10, October 2005”], [“Tunable Polymeric Bragg Grating Filter Using Nanoimprint Technique, Do-Hwan Kim, Won-Jun Chin, Sang-Shin Lee, Seh-Won Ahn and Ki-Dong Lee, Applied Physics Letters 88. 071120 (2006)”]and [“Large Area Direct Nanoimprint of SiO₂—TiO₂ Gel Gratings for Optical Applications, Mingtao Li, Hua Tan, Lei Chen, Jian Wang and Stephen Y. Chou, J. Vac. Sci. Technol. B 21(2), March/April 2003”] for a description of some example implementation details for nanoimprinting of grating structures, the contents of which are hereby incorporated by cross-reference.

Next, a protection layer 411 is formed on the core layer 406 in the area of the grating structure 408. The protection layer 411 is patterned using a shadow mask 412 during the deposition, for example, but not limited to, a sputter deposition. However, in different embodiments other techniques may be used, including, but not limited to a suitable etching method, for example, a photolithography process and a wet etching method in HBr. As mentioned above, the protection layer 411 is patterned in such a way so that the area of the grating structure 408 on the core layer 406 can be protected.

Subsequently, a polymer overclad layer 414 is spin-coated on the core layer 406, followed by curing by baking to form the polymer waveguide structure 416, including the grating structure 408. For example, the cladding and core polymers are baked at about 100-150° C., for about 2-15 mins.

It will be appreciated by a person skilled in the art that various polymer materials and various deposition techniques can be used in the formation of the polymer waveguide structure 416 in embodiments of the present invention. Those materials and deposition techniques are understood in the art.

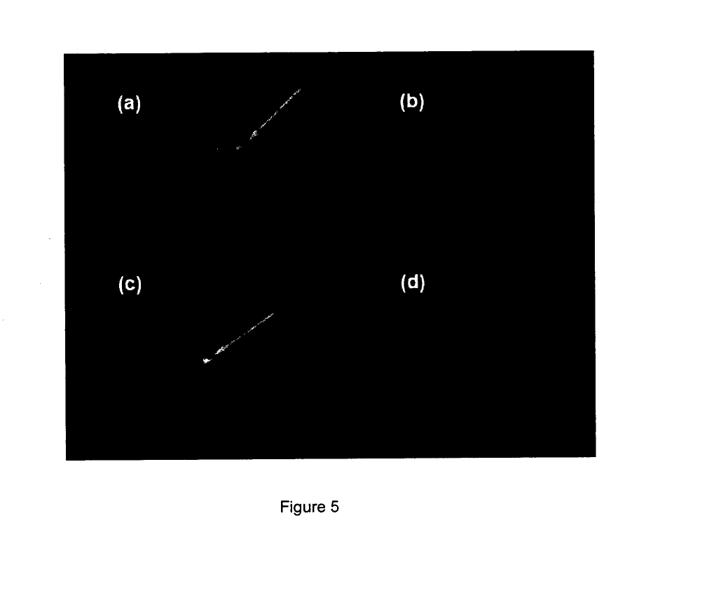

Based on Equation (2), the 1st order light can transmit into the core layer of the waveguide at an incident angle of 30° when a laser of 532 nm is used and an incident angle of 18° when a laser of 630 nm is used. FIG. 5 shows photos of 530 nm and 635 nm laser light coupling in the polymer waveguide with 30° and 18° incident angle, respectively (FIGS. 5(a), (b)), and the light out coupling from the waveguide through the grating areas (FIGS. 5(c), (d)). Part of the emission from the light source can couple to the polymer waveguide and propagate to the edge. The edge emission intensity profile can be measured using a photo diode (PD).

For measurement of the in and out coupling efficiency by comparing photocurrent of edge emission and the top emission with a standard source, the edge emission measurement can make a lateral photocurrent intensity measurement with a PD.

TABLE 1
The coupling efficiency with laser as light source.

| | In coupling | Out coupling |
|---|---|---|
| Laser | efficiency | efficiency |
| 530 nm | 6% ± 1% | 40% ± 5% |
| 635 nm | 4% ± 1% | 35% ± 5% |

A method of fabricating a polymer waveguide for coupling with light transmissible devices according to an example embodiment. comprises providing a grating structure in the polymer waveguide.

A method of coupling a polymer waveguide with light transmissible devices according to an example embodiment uses a grating structure formed in the polymer waveguide structure.

Example embodiments of the present invention provide a built-in grating structure, made for example with nanoimprinting, for enhancing light coupling at the OLED/WG and OPD/WG interfaces and have the potential to meet cost competiveness while preferably maintaining a high throughput and high resolution, and easy control of the depth of the pattern.

Example embodiments of the present invention provide a top and bottom approach for e.g. light source and detector integrated on a waveguide in order to achieve high coupling efficiency by increment of the incident angle of light emission into the waveguide via the grating area created by e.g. nanoimprint technology.

Example embodiments of the present invention provide an integration of light transmissible devices with a polymer waveguide. The light transmissible devices can include, but is not limited to, a laser, a solid-state lighting, an organic light emitting diode, a polymer light emitting diode, a light emitting diode, an electroluminescent component, an inorganic photodetector, an organic photodetector or a combination thereof.

Example embodiments of the present invention provide an organic system that offers an attractive alternative for achieving low cost plastic electronics. Light source and photo-detector on polymer waveguides as the key component in plastic electronic can have the advantages in terms of cost effectiveness, chemical tenability and flexibility. In addition, they are easily produced on a millimeter or micron scale in large areas, as well as being very lightweight and portable, and not constrained by one integration device.

Example embodiments of the present invention advantageously provide an approach for coupling light in and out of a polymer waveguide, which can be applied on flexible substrates. Example embodiments of the present invention provide a grating area, fabricated e.g. via nanoimprint, with a protection layer in the multilayer waveguide such that light can directly couple in and out of the core layer of the waveguide. Advantages of the embodiments include that the integrated structure is mechanically flexible, which can potentially be fabricated onto flexible substrates, no angular cut mirror is required in the structure, no requirement for specially designed light sources and detectors, and that the approach or fabrication method does not affect the top surface and function of the waveguide.

Example embodiments of the present invention can provide polymer waveguide sensor technology, based on the integration of organic light transmissible and accepting devices, such as OLEDs and OPDs with polymer waveguides, which can provide potentially significant process flexibility, cost benefit, as well as the functional superiority for a broad range of applications including, but not limited to, in wearable units, disposable point of diagnostics, low cost bioassay device, lab-on-chip, vital sign monitoring, robots and compact information systems. Example embodiments of the present invention can provide an approach for guiding the light into and out of the polymer waveguide for e.g. sensor and telecommunication applications.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A polymer waveguide for coupling with one or more light transmissible devices, wherein the polymeric waveguide comprises a grating structure.

2. The polymer waveguide as claimed in claim 1, wherein the polymer waveguide comprises an underclad layer, a core layer and an overclad layer, and the grating structure is formed at an interface between the overclad layer and the core layer, or at an interface between the underclad and the core layer.

3. The polymer waveguide as claimed in claim 2, wherein the polymer waveguide is disposed on a substrate.

4. The polymer waveguide as claimed in claim 2 or 3, wherein the grating structure is formed in the core layer of the polymeric waveguide.

5. The polymer waveguide as claimed in any one of claims 1-4, wherein the grating structure is periodic.

6. The polymer waveguide as claimed in any one of claims 1-5, wherein the periodic grating structure is corrugated.

7. The polymer waveguide as claimed in claim 5, wherein the periodic grating structure has an oscillating refractive index along a plane substantially parallel to the light transmissible devices.

8. The polymer waveguide as claimed in claim 3, wherein the substrate comprises one of a group consisting of PET, glass, a stainless steel foil, a plastic sheet, a circuitry backplane, and a flexible substrate.

9. The polymer waveguide as claimed in any one of claims 1-8, wherein the grating structure is fabricated by nano- or micro-fabrication method.

10. The polymer waveguide as claimed in claim 9, wherein the grating structure is fabricated by one of a group consisting of nanoimprint, e-beam etch and photo-lithography.

11. The polymer waveguide as claimed in claim 10, wherein the period of the grating is tuned by the nanoimprint process.

12. The polymer waveguide as claimed in any one of claims 1-11, wherein the grating structure changes a propagation direction of light emission from the light transmissible device.

13. The polymer waveguide as claimed in any one of claims 1-12, configured for coupling of light from one or more light transmissive devices, and/or coupling of light to one or more light transmissive devices.

14. The waveguide as claimed in any one of claims 1-13, wherein the one or more light transmissible devices are selected from a group consisting of laser, a solid-state lighting, an organic light emitting diode, a polymer light emitting diode, a light emitting diode, an electroluminescent unit, an inorganic photodetector, an organic photodetector or a combination thereof.

15. A method of fabricating a polymer waveguide for coupling with one or more light transmissible devices, the method comprising the step of providing a grating structure in the polymer waveguide.

16. The method as claimed in claim 15, wherein the polymer waveguide comprises an underclad layer, a core layer and an overclad layer, and the grating structure is formed at an interface between the overclad layer and the core layer, or at an interface between the underclad and the core layer.

17. The method as claimed in claim 15 or 16, wherein the step of providing the grating comprises nanoimprint, e-beam etch or photolithography.

18. The method as claimed in any one of claims 15 to 17, further comprising the step of depositing a transparent protective layer in an area of the grating structure.

19. The method as claimed in claim 18, wherein the transparent protective layer is selected from a group consisting of ZnO, SnO₂, In₂O₃, Al₂O₃, NiO, CaF₂, an organic material suitable for application in a grating, and inorganic material suitable for application in a grating, or a combination thereof.

20. The method as claimed in claim 18 or 19, wherein the transparent protective layer further comprises a transparent conducting layer.

21. The method as claimed in claim 20, wherein the transparent conducting layer comprise transparent conducting oxides such as indium-tin-oxide (ITO), zinc-indium-oxide, aluminum-doped zinc oxide, Ga—In—Sn—O, SnO2, Zn—In—Sn—O, Ga—In—O, TiNbO, ZSO, NiOx or a combination of transparent conducting oxides.

22. The method as claimed in claim 20 wherein the transparent conducting layer comprise ultra-thin metallic or modified metallic materials such as Au, Ag/CFx or any transparent conducting layer suitable for application in OLEDs and OPDs.

23. The polymer waveguide as claimed in any one of claims 1 to 14, further comprising a transparent protective layer in an area of the grating structure.

24. The polymer waveguide as claimed in claim 23, wherein the transparent protective layer is selected from a group consisting of ZnO, SnO₂, In₂O₃, Al₂O₃, NiO, CaF₂, an organic material suitable for application in a grating, and inorganic material suitable for application in a grating, or a combination thereof.

25. The polymer waveguide as claimed in claim 23 or 24, wherein the transparent protective layer further comprises a transparent conducting layer.

26. The method as claimed in claim 25, wherein the transparent conducting layer comprise transparent conducting oxides such as indium-tin-oxide (ITO), zinc-indium-oxide, aluminum-doped zinc oxide, Ga—In—Sn—O, SnO2, Zn—In—Sn—O, Ga—In—O, TiNbO, ZSO, NiOx or a combination of transparent conducting oxides.

27. The method as claimed in claim 25 wherein the transparent conducting layer comprise ultra-thin metallic or modified metallic materials such as Au, Ag/CFx or any transparent conducting layer suitable for application in OLEDs and OPDs.

28. A method of coupling a polymer waveguide with one or more light transmissible devices using a grating structure formed in the polymer waveguide structure.
